(19) United States
(12) Patent Application Publication
(10) Pub. No.: US 2009/0244040 A1
(43) Pub. Date: Oct. 1, 2009

(54) PLASMA DISPLAY PANEL, DRIVING METHOD OF PLASMA DISPLAY PANEL, AND PLASMA DISPLAY APPARATUS

(75) Inventors: Yoshiho SEO, Yokohama (JP); Keiichi Betsui, Yokohama (JP); Tadayoshi Kosaka, Yokohama (JP); Takeo Masuda, Miyazaki (JP); Ikuo Ozaki, Miyazaki (JP); Masashi Ohta, Miyazaki (JP); Masafumi Kamakura, Miyazaki (JP); Makoto Saitou, Miyazaki (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/336,424

(22) Filed: Dec. 16, 2008

(30) Foreign Application Priority Data
Mar. 28, 2008 (JP) 2008-085752

(51) Int. Cl. G09G 5/00; G09G 3/28

(52) U.S. Cl. 345/208; 345/60

(57) ABSTRACT

The present invention provides a technique relating to a PDP and capable of canceling or reducing luminance unevenness due to voltage drop or the like. In a structure of the PDP, for example, two types of cells different in discharge timing are arranged in a zigzag manner on a screen. For example, the two types of cells have different discharge gap lengths because of a difference in areas and lengths of projections of electrodes of the respective cells. By the dispersion of discharge timings of cells, the voltage drop or the like is reduced. The design characteristic obtained by the arrangement pattern is superimposed on panel manufacture characteristic, whereby luminance unevenness is cancelled or reduced in display characteristic.

### CROSS-REFERENCE TO RELATED APPLICATION

The present application claims priority from Japanese Patent Application No. JP 2008-085752 filed on Mar. 28, 2008, the content of which is hereby incorporated by reference into this application.

### TECHNICAL FIELD OF THE INVENTION

The present invention relates to a display device utilizing discharge such as a plasma display panel (PDP), and more particularly to a structure of a cell (discharge cell) and a countermeasure against voltage drop or the like.

### BACKGROUND OF THE INVENTION

In a PDP, a pulse-like discharge current is supplied as a drive waveform for display discharge (sustain discharge) or the like from a drive control circuit side via a bus electrode. Such a phenomenon as voltage drop (discharge drop) of the bus electrode occurs due to the concentration (peak value increase) of discharge current.

Regarding the above, Japanese Patent No. 3547267 describes a technique of varying the width of electrodes (projecting portions) or the like in the respective cells in a bus electrode extending direction for the purpose of reducing a peak value of discharge current.

Also, Japanese Patent No. 3864204 describes a technique of varying the electrode area or the like in the respective cells of each color R, G, and B for the purpose of adjusting a color temperature of white display.

### SUMMARY OF THE INVENTION

Due to the increase of wiring resistance resulting from a panel size increase, voltage drop of a bus electrode or the like caused by the concentration (peak value increase) of discharge current is increased. As a result, luminance unevenness occurs due to the difference in discharge timing caused by minute difference in cell discharge characteristics.

The details thereof are as follows. For example, in a cell (average cell) which discharges (lights up) at the same timing as an average cell, the luminance is lowered because the voltage drop is occurring therein. On the other hand, since a cell which discharges at a timing earlier than or later than the average cell is not influenced by the voltage drop or influence thereto is small, luminance of the cell is higher than that of the average cell (FIG. 10).

It is considered that such a difference in discharge timing (difference in cell discharge characteristics) is caused from the difference in panel manufacture characteristics, namely, a minute structural difference formed in the course of panel manufacture, a material characteristic difference and others.

The present invention has been made in view of the problem as described above, and a principal object thereof is to provide a technique relating to a PDP and capable of canceling or reducing luminance unevenness due to the voltage drop or the like and improving the display quality.

The typical ones of the inventions disclosed in this application will be briefly described as follows. In order to achieve the above object, a representative embodiment of the present invention is directed to a technique for a PDP, a PDP driving method and a PDP apparatus and is characterized by including a configuration described below.

A PDP according to the present embodiment is provided with plural types of cells intentionally designed to have a discharge characteristic with a predetermined difference so that the discharge timing thereof differs with respect to the discharge timing obtained by the application of a drive waveform to a cell to be a reference (average). In the plural types of cells, discharge timing is varied by controlling the characteristics (length, position and others) of the discharge gap by changing the electrode shapes of respective cells.

Further, the plural types of cells are distributed and arranged in a predetermined pattern in a screen of the PDP. This arrangement pattern is set to a pattern obtained by spatial frequency hardly recognized as noises (unevenness) visually by human eyes in a plane including an electrode extending direction (lateral direction) and a direction orthogonal thereto (vertical direction) of a screen. More specifically, for example, the plural types of cells are arranged in a sequentially repetitive pattern so that cells of different types are arranged adjacent to each other. For example, two types of cells are arranged in a zigzag pattern (alternately).

Alternatively, arrangement patterns other than a completely regular arrangement pattern can be adopted. For example, plural types of cells are arranged on a screen in a regular pattern so that cells of the same type are arranged adjacent to each other in some parts and cells of different types are arranged in a sequentially repetitive manner as far as possible in other parts, or arranged in a pattern obtained by a known error diffusion processing. In this case, it is visually preferable to adopt the pattern where a portion where cells of the same type are arranged adjacent to each other is contained in a block with a size of 2×2 at a maximum.

Also, it is preferable to design so that the discharge timings of respective cells in the plural types of cells vary by about a half-height full-width of the discharge current.

With the configuration mentioned above, design characteristics based on the arrangement pattern (discharge timing (luminance) dispersion characteristics) are superimposed on the panel manufacture characteristics (random and minute cell discharge characteristic difference and luminance unevenness due to that), and the luminance unevenness due to the causes mentioned above is reduced in the display characteristics at the time of the utilization of this panel. Difference in discharge timing occurs between cells at the time of display discharge and discharge currents are dispersed by the superimposition thereof. Accordingly, a degree of vertical fluctuation such as voltage drop is reduced as compared with the conventional art, so that the luminance unevenness is reduced.

For example, in the PDP of the present invention, plural types of cells different in discharge timing with respect to a reference waveform application are provided, the plural types of cells have different discharge timings because lengths of discharge gaps are varied by electrode shapes of the respective cells, and the plural types of cells are arranged on a screen in a sequentially repetitive pattern so that cells of different types are arranged in adjacent cells.

Also, in a PDP driving method and a PDP apparatus according to the embodiment, in the application of drive waveforms to electrodes used for display discharge, a first drive waveform which generates rising to a predetermined voltage and overshoot at a first timing coinciding with a discharge timing of the first cell and a second drive waveform which generates rising to a predetermined voltage and overshoot at a second timing coinciding with a discharge timing of the second cell are applied in a switched manner.

An effect obtained by the representative ones of the inventions disclosed in this application will be briefly described below. According to the representative embodiments of the present invention, in a PDP, luminance unevenness due to voltage drop or the like is cancelled or reduced and display quality can be improved.

Especially, the maximum amount of the voltage drop is reduced by the difference (dispersion) in discharge timings, and the luminance difference in respective cells is reduced. Also, even if there is a panel manufacture characteristic difference, it is possible to make it hard to see the luminance unevenness due to the difference.

### BRIEF DESCRIPTIONS OF THE DRAWINGS

FIG. 1 is a diagram showing a configuration example of a PDP apparatus according to an embodiment of the present invention;

FIG. 2 is a partially exploded perspective view showing a structure example of a PDP according to an embodiment of the present invention;

FIG. 3 shows diagrams of a design concept of cell discharge current targeted in the PDP according to an embodiment of the present invention, in which discharge current of a cell (cell to be reference) in the conventional art is shown in FIG. 3A and discharge current at the time of a discharge dispersion of the cells (two types of cells) according to the present embodiment is shown in FIG. 3B;

FIG. 4 shows diagrams for describing the design of the discharge timing difference of the waveforms corresponding to those of FIG. 3 in the PDP according to an embodiment of the present invention;

FIG. 5 shows diagrams for describing an operation effect of the present embodiment with respect to the conventional art in the PDP according to an embodiment of the present invention, in which a drive waveform and discharge light emissions in the conventional art are shown in FIG. 5A, and a drive waveform and discharge light emissions according to the present embodiment are shown in FIG. 5B;

FIG. 6 is a diagram for describing the display characteristic (effect) (C) obtained by superimposition of the panel manufacture characteristic (A) on the design characteristic based on an arrangement pattern (B) in the PDP according to an embodiment of the present invention;

FIG. 7 is a diagram showing a cell structure of the PDP according to the first embodiment of the present invention;

FIG. 8 is a diagram showing a cell structure of the PDP according to the second embodiment of the present invention;

FIG. 9 shows diagrams of the design of cells and drive waveforms in a PDP, a PDP driving method, and a PDP apparatus according to the fifth embodiment of the present invention, in which drive waveforms and discharge light emissions are shown in FIG. 9A and examples of drive waveform for display discharge to the display electrode pair are shown in FIG. 9B; and

FIG. 10 is a diagram showing a drive waveform and timings of discharge light emission in the conventional art.

### DESCRIPTIONS OF THE PREFERRED EMBODIMENTS

Hereinafter, embodiments of the present invention will be described in detail with reference to the accompanying drawings. Note that components having the same function are denoted by the same reference numbers throughout the drawings for describing the embodiments, and the repetitive description thereof will be omitted.

<Conventional Art>

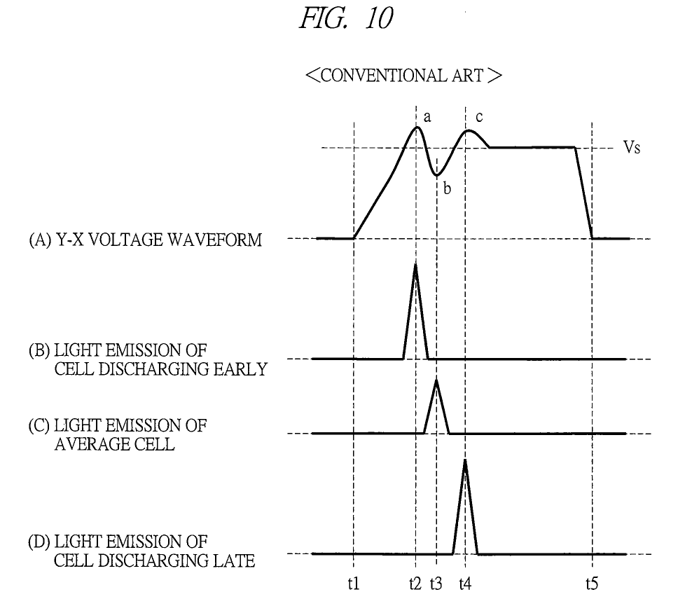

A conventional art (basic mechanism of voltage drop or the like) will be briefly described with reference to FIG. 10. FIG. 10 shows a drive waveform and timings of discharge light emission in a PDP of the conventional art. In FIG. 10, (A) denotes a voltage waveform (unit pulse only) for sustain discharge (display discharge) applied to a bus electrode of a display electrode pair (Y-X), (B) denotes light emission of a cell discharging early, (C) denotes light emission of an average cell, and (D) denotes light emission of a cell discharging late.

In (A), the waveform rises up to a predetermined voltage Vs from a timing t1, and after maintaining the voltage Vs, it falls down by a timing t5.

In the discharge drive to the display electrode pair (Y-X), since all cells of the electrode pair discharge approximately at the same time and large current flows instantaneously, the voltage drop or the like occurs due to the wiring resistance of electrodes. Fluctuation (ringing) occurs in a voltage of a bus electrode as a whole due to the concentration of discharge current. More specifically, the voltage fluctuates up and down from a reference (Vs) as shown by “a”, “b” and “c”. Note that this example shows a case of three stage change of “a”, “b” and “c” for simplification.

Differences in discharge timing occur in respective cells on a screen due to discharge characteristic differences as shown in (B), (C) and (D), so that luminance unevenness is generated due to differences in discharge light emission amount. It is considered that the discharge characteristic difference is caused by a minute structural difference, a material characteristic difference and the like formed in the course of panel manufacture.

Specifically, since the cell which discharges (lights up) at a timing t2 as shown by (B) is in an overshoot state, namely, a voltage exceeds the reference value (Vs) as shown by “a” of the waveform of (A), the light emission is accordingly larger than the reference, and the luminance becomes high.

Also, since the cell which discharges at a timing t3 as shown by (C) is in a voltage drop state, namely, a voltage is lower than the reference value (Vs) as shown by “b”, the light emission is accordingly smaller than the reference, and the luminance becomes low.

Further, since the cell which discharges at a timing t4 as shown by (D) is also in the overshoot state as shown by “c”, the light emission is accordingly larger than the reference, and the luminance becomes high.

<PDP Apparatus>

In light of the above, embodiments of the present invention will be described. A background configuration is first described, and then a characteristic configuration will be described. Note that an x direction (first direction, horizontal direction in the screen), a y direction (second direction, vertical direction in the screen), and a z direction (third direction, vertical direction to a panel plane) are provided for description.

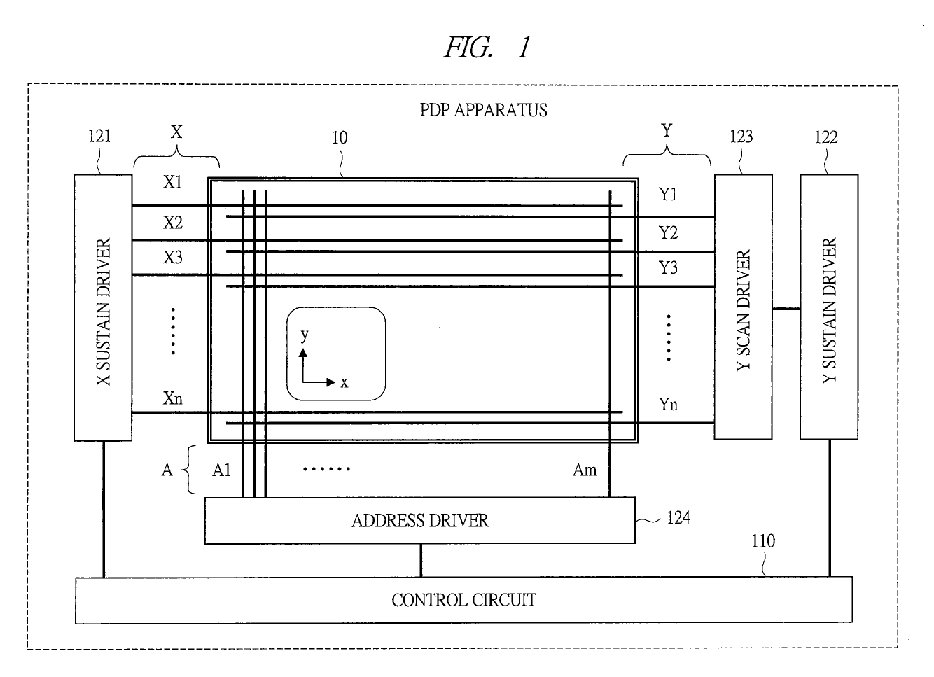

FIG. 1 shows an entire configuration of a PDP apparatus according to an embodiment. The PDP apparatus is provided with a PDP (panel) 10 in which electrode groups (sustain electrodes X, scan electrodes Y and address electrodes A) are formed, an X sustain driver (X electrode sustain drive circuit) 121, a Y sustain driver (Y electrode sustain drive circuit) 122, a Y scan driver (Y electrode scan drive circuit) 123 and an address driver (address electrode drive circuit) 124, each of which is a drive circuit (driver) connected to the electrode group of the PDP 10 and applies a drive voltage thereto, and a control circuit 110 controlling these drive circuits.

In the PDP 10, pairs of sustain electrodes (represented by symbol X) and scan electrodes (represented by symbol Y) are formed in parallel to the x direction of the screen as the electrodes (display electrodes) used for sustain discharge (display discharge), and the display lines are configured by the electrode pairs. Also, address electrodes (represented by symbol A) are formed in parallel to the y direction of the screen so as to intersect these electrode pairs, and the display columns are configured by the electrodes. Also, on the screen (display region) of the PDP 10, cells (discharge cells) are configured in a matrix manner so as to correspond to intersecting regions of these electrode groups (X, Y and A).

For example, data showing luminance levels of three colors of red (R), green (G) and blue (B), various synchronous signals (clock signal, horizontal synchronization signal and vertical synchronization signal) and others are input to the PDP apparatus from an external apparatus such as a TV tuner or a computer. Also, the control circuit 110 generates and outputs control signals suitable for respective drivers based on the data and signals. In accordance with the input, the drivers drive corresponding electrode groups by the application of voltages (waveforms). In this manner, a video image is displayed on the screen of the PDP 10 in accordance with a predetermined method.

As an example of an electrode arrangement of the PDP 10, sustain electrodes X (X1 to Xn) and scan electrodes Y (Y1 to Yn) are alternately and repeatedly arranged in the y direction in the case of a normal method, and display lines formed by the display electrode pairs (X-Y) are sequentially arranged. Also, cells are configured by the address electrodes (A1 to Am) intersecting the display lines.

<Drive Method>

In a drive method of the present PDP apparatus, a field associated with the screen of the PDP 10 is driven by a sub-field method, an address display separation method, and the like. In the drive sequence, the field (or frame) includes a plurality of sub-fields (or sub-frames) each having predetermined weight of luminance applied thereto. Grayscale expression is performed for each cell by selection and combination of lighting-up of respective sub-fields (SF) of the field. Each SF period has respective operation periods such as a reset period, an address period, and a sustain (display) period. A ratio of the number of sustain discharges during the sustain period varies in accordance with the weight of SF.

In an example of the SF drive sequence, states of all cells in SF are initialized in the reset period to prepare for the address period. Specifically, by applying a reset waveform from a reset circuit to the display electrode (X, Y) group, discharge for charge adjustment is generated. In the next address period, cells to be lit (ON)/unlit (OFF) in the SF are selected. Specifically, the Y scan driver 123 performs an operation (scan) for controlling the individual scan electrodes Y (display line) to sequentially select them. Simultaneously therewith, the address driver 124 performs an operation for controlling the individual address electrodes A to select them. By these operations, cell selection discharges (address discharges) are generated at the pair of (between) the address electrode A and the scan electrode Y to be selected. In the next sustain period, the cells which have been selected in the previous address period are lit by sustain discharge light emission. Specifically, the X sustain driver 121 and the Y sustain driver 122 apply a number of sustain waveforms corresponding to the weight to the display electrode (X, Y) group. By this means, a number of sustain discharges corresponding to the weight are generated in the selected cells.

<PDP>

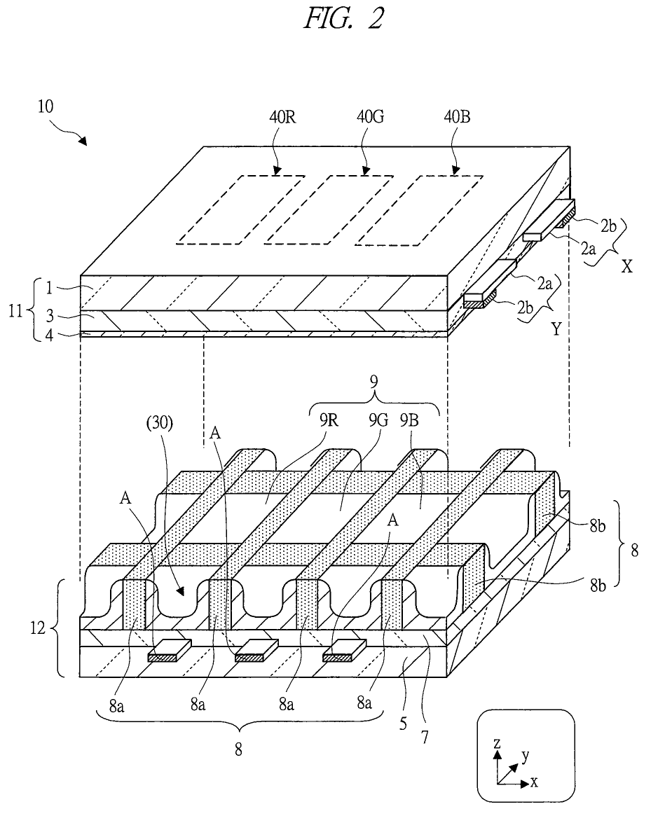

FIG. 2 shows an example of a basic structure of the PDP 10 provided in the PDP apparatus. Only a part corresponding to the cells of respective colors (R, G, B) which is equivalent to a pixel in the PDP 10 is shown. Light emission regions 40R, 40G and 40B correspond to the cells of respective colors.

The PDP 10 is configured by combining two structures (11, 12) mainly formed of two glass substrates 1 and 5 positioned on a front side and a back side. A discharge space 30 is formed by sealing the outer peripheral portions of these structures (11, 12), degassing a region (inside) between the structures, and filling discharge gas in the region.

In the first structure (front substrate structure) 11, display electrodes (X, Y) are formed on the glass substrate 1 so as to extend in parallel to the x direction. The sustain electrodes X for sustain drive and the scan electrodes Y for both sustain drive and scan drive are provided. The display electrodes (X, Y) are formed of, for example, transparent electrodes 2a and bus electrodes 2b. End portions of the bus electrodes 2b are connected to a driver side. The display electrodes (X, Y) are covered with a dielectric layer 3 and a protective layer 4.

In the second structure (back substrate structure) 12, address electrodes A for address drive are formed on the glass substrate 5 so as to extend in parallel to the y direction. The address electrodes A are covered with a dielectric layer 7, and barrier rib portions (vertical ribs) 8a extending in the y direction and barrier rib portions (lateral ribs) 8b extending in the x direction are formed on the dielectric layer 7 as barrier ribs 8. The barrier rib 8 in this case has a box (grid) shape. The barrier rib 8 partitions the discharge space 30 so as to correspond to the cells (discharge regions). Phosphors 9 (9R, 9G and 9G) of respective colors are separately formed in the regions partitioned by the barrier rib 8 on the dielectric layer 7 so as to be exposed to the discharge space 30.

Other than the structure of the PDP 10 described above, various specific structures can be adopted in accordance with a drive method. For example, in the case of the so-called ALIS method, display lines are configured by all the adjacent pairs of display electrodes (X, Y), and an image displayed on the screen is displayed by the interlace drive of odd fields which drive the odd display lines and even fields which drive the even display lines.

<Characteristic Configuration>

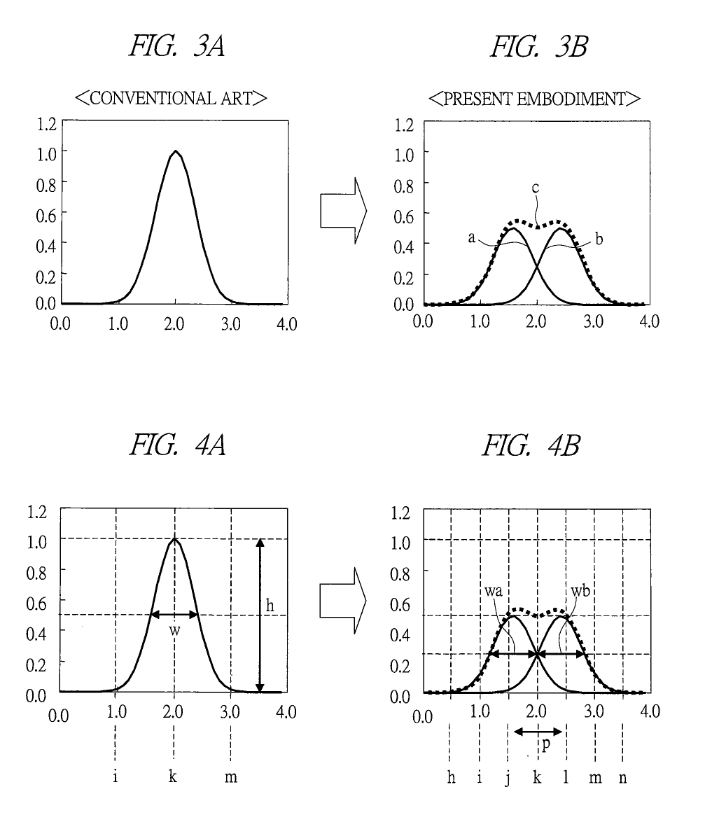

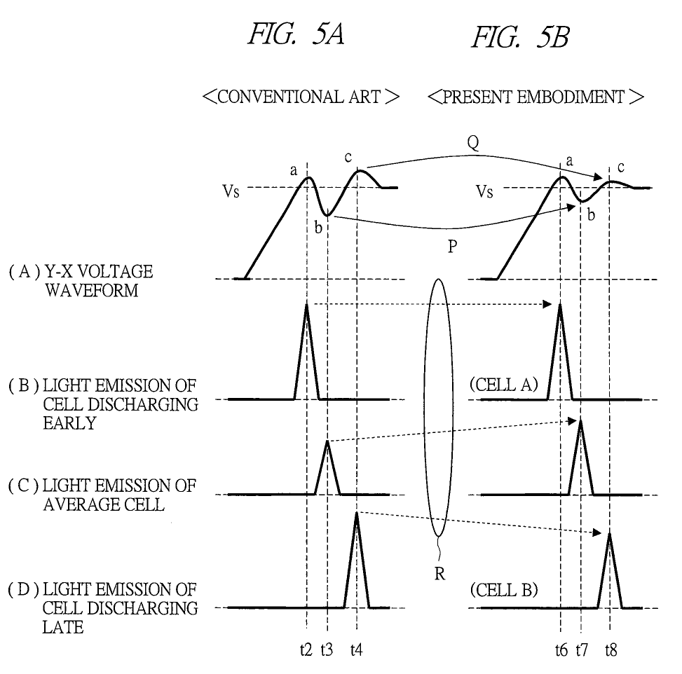

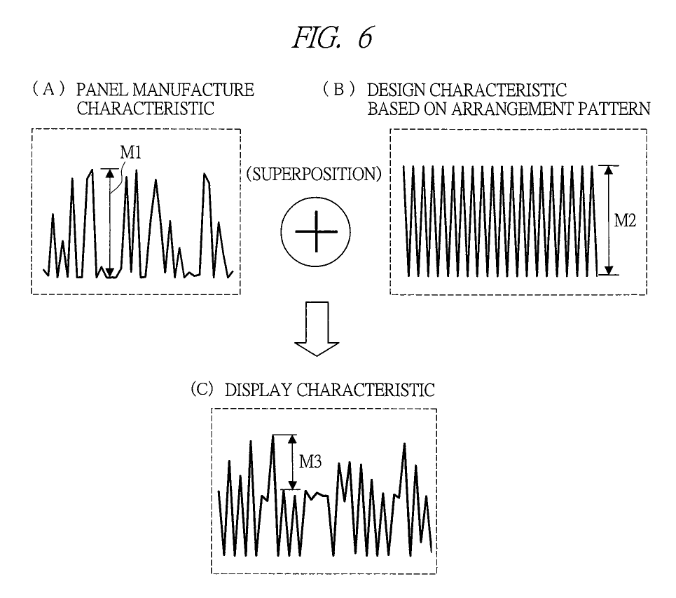

A characteristic configuration (basic design concept, operation effect, and others) in the PDP according to an embodiment (first embodiment and others) of the present invention will be described with reference to FIG. 3 to FIG. 6 and others. A specific configuration thereof will be described later. FIGS. 3 and 4 show a design concept of cell discharge current targeted in the PDP, where FIG. 3A shows discharge current of one cell serving as reference (average) in a PDP in the conventional art, and FIG. 3B shows discharge currents of two types of cells (A, B) at the time of discharge dispersion in the present PDP. FIG. 4A and FIG. 4B show the width and height of the waveform, discharge timings, and others of FIG. 3A and FIG. 3B. FIG. 5 shows the drive waveforms of display discharges and discharge light emissions at respective timings of the display discharges, where FIG. 5A shows a case of the conventional art and FIG. 5B shows an operation effect of the present PDP. FIG. 6 shows respective characteristics in the design of the present PDP, where (A) denotes panel manufacture characteristic, (B) denotes design characteristic based on an arrangement pattern, and (C) denotes display characteristic (effect) obtained by superimposing the panel manufacture characteristic and the design characteristic on each other.

In FIG. 3, in the present PDP, dispersion of discharge currents (a, b) by two types of cells (A, B) different in discharge timing is designed as shown in FIG. 3B with respect to the total discharge current shown in FIG. 3A. In FIGS. 3 and 4, a vertical axis represents a current amount unit and a horizontal axis represents a time unit. In FIG. 3B, “a” is a discharge current (discharge waveform) of a first cell A discharging early, and “b” is a discharge current (discharge waveform) of a second cell B discharging late. Further, “c” is a discharge current (discharge waveform) of the sum of “a” and “b”. When the same drive waveform is applied to the respective cells (A, B), a timing difference occurs like “a” and “b”. By this dispersion, the height of the total discharge current is suppressed as shown by “c” compared with the height in FIG. 3A.

In FIG. 4, discharge timings of the two types of cells (A, B) are designed so as to have a predetermined difference as shown in FIG. 4B. It is preferable that the discharge timings of the two types of cells (A, B) vary by about a half-height full-width of the discharge current like in this example. In FIG. 4B, with respect to the half-height full-widths wa and wb of discharge currents of “a” and “b”, the difference (difference in discharge timing) between the discharge currents of “a” and “b” which is shown by “p” has a relation of p=wa=wb. A total wave height value “c” is suppressed by the difference “p”.

Note that, in the example of discharge current of FIGS. 3A and 4A, the total height is about 1.0, the width is about 2.0 (timing of i=1.0 to m=3.0 and center timing k=2.0), and the half-height full-width thereof is w (about 1.0 or less). On the other hand, in “a” and “b” in FIGS. 3B and 4B, the total height is about 0.5, the width is about 2.0, and the half-height full-widths thereof are wa and wb (about 1.0 or less). In the discharge current “c”, the total height is about 0.5 and the width is about 3.0. A difference in timing between the peak values of “a” and “b” is p=wa=wb (about 1.0 or less).

In FIGS. 5A and 5B, (A) denotes a drive voltage waveform (sustain pulse) for sustain discharge to an electrode pair (Y-X) using the sustain discharge. Vs denotes a predetermined voltage. Also, “a”, “b”, and “c” denote examples of voltage fluctuation portions. In FIGS. 5A and 5B, (B), (C) and (D) denote discharge light emissions of respective cells having different discharge timings. (B) denotes the light emission (timing: t2, t6) of a cell discharging early, (C) denotes the light emission (timing: t3, t7) of an average cell, and (D) denotes the light emission (timing: t4, t8) of a cell discharging late. Further, “a” denotes an overshoot state, “b” denotes a voltage drop state, and “c” denotes a ringing state (another overshoot state). Also, P denotes voltage drop reduction in the transition from a state of “b” in FIG. 5A to a state of “b” in FIG. 5B. Further, Q denotes voltage ringing reduction in the transition from a state of “c” in FIG. 5A to a state of “c” in FIG. 5B. Further, R denotes the changes of discharge light emission intensity in (B), (C) and (D), thereby showing the reduction of light emission intensity difference.

By adopting a structure in which respective cells (A, B) in the PDP are intentionally designed to have different discharge timings as shown in FIGS. 3A and 3B, the maximum value in such a phenomenon as voltage drop of “b” is reduced as shown by P and Q.

In the conventional art of FIG. 5A, since the overshoot state of “a” occurs in the light emission at the timing t2 of (B), the light emission amount becomes large. Since the drop state of “b” occurs in the light emission at the timing t3 of (C), the light emission amount becomes small. Since the overshoot state of “c” occurs in the light emission at the timing t4 of (D), the light emission amount becomes large.

On the other hand, the present PDP shown in FIG. 5B includes a cell (assumed average cell) discharging at the timing t7 of the drop of “b” as shown by (C) and respective cells (A, B) discharging at timings t6 and t8 before and after the drop state of “b” as shown by (B) and (D). Note that (C) shown as light emission of an average cell in FIG. 5B assumes that an average cell between the two types of cells (A, B) like (B) and (D) is present. In the present PDP, the luminance difference between the light emission of (C) and the light emissions of (B) and (D) is reduced.

In the correlation between the timings of the phenomena of “a”, “b” and “c” shown in FIG. 5 and the timing of the discharge current shown in FIG. 4, the timings t2 and t6 of “a” in FIGS. 5A and FIG. 5B correspond to i=1.0 in FIGS. 4A and 4B. The timings t3 and t7 of “b” in FIGS. 5A and 5B correspond to k=2.0 in FIGS. 4A and FIG. 4B. The timings t4 and t8 of “c” in FIGS. 5A and 5B correspond to m=3.0 in FIGS. 4A and 4B.

In FIG. 6, even if there is a minute characteristic difference (panel manufacture characteristic difference) unintentionally produced in the panel manufacture as shown by (A), luminance difference (M2) larger than luminance difference (M1) due to the characteristic difference is designed in the arrangement pattern shown by (B). By this means, it is possible to make it hard to see the luminance unevenness caused by the panel manufacture characteristic of (A) as shown in the display characteristic at the time of actual utilization of (C).

In the panel manufacture characteristic (random and minute unevenness of panel) shown by (A) of FIG. 6, M1 is an example of the luminance difference to be recognized as unevenness. In the luminance (discharge timing) dispersion characteristic based on the design of the arrangement pattern of (B), M2 is the luminance difference on design (M2>M1). Also, (C) is the display characteristic obtained by superimposition of (A) and (B), which shows the reduction effect of a luminance difference obtained by the reduction of voltage drop or the like. M3 is an example of unevenness (luminance difference) which has been reduced by the superimposition.

### First Embodiment

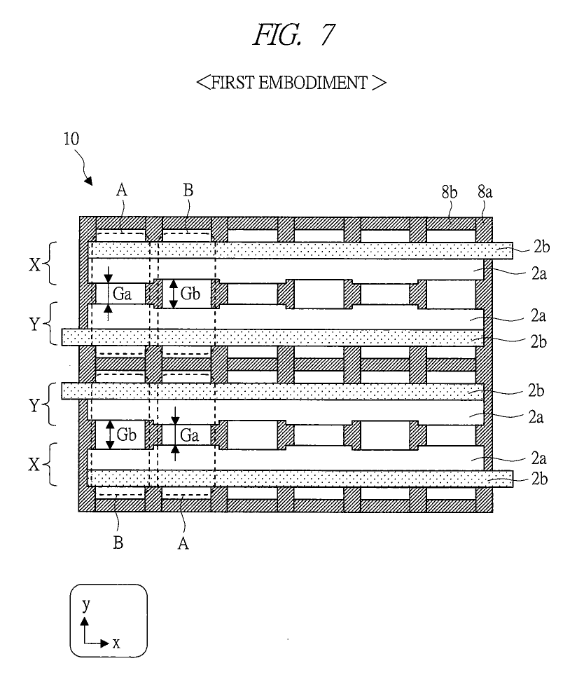

Next, a cell structure (including electrode structure and the like) in a screen (x-y plane) of the PDP 10 according to a first embodiment is shown in FIG. 7 as a specific structure. In the structure of the first embodiment, as shown in FIG. 7, two types of cells (A, B) having different discharge gap lengths (Ga, Gb) are provided, and these cells (A, B) are arranged in a zigzag pattern on a panel screen.

The first cell A is a cell which discharges at an early timing, and the second cell B is a cell which discharges at a late timing. The cell A has a short discharge gap length (Ga), and the cell B has a long discharge gap length (Gb). In other words, both the sustain electrode X and the scan electrode Y (transparent electrode 2a) have large areas in the cell A, and both the sustain electrode X and the scan electrode Y (transparent electrode 2a) have small areas in the cell B.

In the zigzag arrangement pattern, the cells A and the cells B are alternately arranged in both the x direction and the y direction, and different types of cells are arranged in adjacent cells, respectively. An arrangement ratio of the first cells A and the second cells B in a screen is set to 1:1 (each 50%) for the average dispersion.

Note that, in the example of the present cell structure, the electrode pairs of X-Y positioned reversely are repeatedly arranged in the barrier rib 8 of a box type similar to that shown in FIG. 2, and the transparent electrodes 2a is common to the bus electrode 2b and they are rectangular for each cell.

In a region of the discharge space 30 corresponding to a screen, each cell (A, B) is configured as a closed discharge light emission region surrounded by the barrier rib 8 of the box type and the bus electrode 2b. In this case, the bus electrode 2b of the display electrode (X, Y) is arranged so as to slightly project in a cell inner side direction with respect to the lateral rib 8b. The bus electrode 2b is formed in a thin linear shape continuous over a whole length in the x direction and is made of metal with low electric resistance. In each of the display electrodes (X, Y), the transparent electrode 2a is overlapped on and connected to the bus electrode 2b, and a portion of the transparent electrode 2a projects in a rectangular shape from the bus electrode 2b in the cell inner side direction. The transparent electrode 2a is made of a transparent material such as ITO and discharge gaps (Ga, Gb) are defined by rectangular distal ends of the transparent electrodes 2a of X-Y in the cell. The transparent electrode 2a is connected commonly to the cells in the x direction, but it may be separated for each cell.

In the cell A, the lengths of the rectangular projections (y direction) of the transparent electrodes 2a of X and Y are relatively large, and a relatively short discharge gap Ga is configured. On the contrary, in the cell B, the lengths of the rectangular projections (y direction) of the transparent electrodes 2a of X and Y are relatively small, and a relatively long discharge gap Gb is configured.

As described above, according to the PDP 10 of the present embodiment, by adopting the structure of the zigzag arrangement pattern of the two types of cells (A, B), luminance unevenness due to voltage drop can be cancelled or reduced, and the display quality can be improved. Especially, by the difference (dispersion) in discharge timing in the cells (A, B), the maximum amount of the voltage drop or the like is reduced, and the luminance difference between respective cells having different discharge timings with respect to a predetermined waveform (sustain pulse) is reduced. Even if there is a panel manufacture characteristic difference, it is possible to make it hard to see the luminance unevenness due to the characteristic difference.

### Second Embodiment

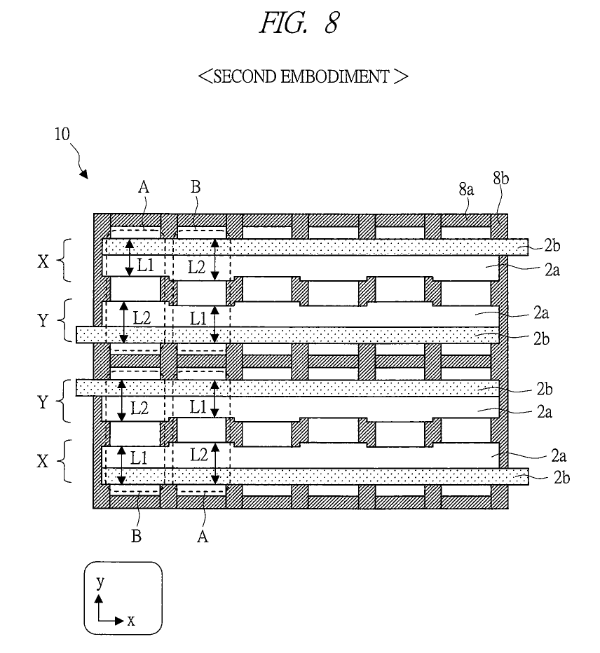

Next, FIG. 8 shows a cell structure on a screen of the PDP 10 according to a second embodiment in the same manner as the first embodiment. The difference of the second embodiment from the first embodiment lies in that positions of discharge gaps of the two types of cells (A, B) are varied in the y direction. In the second embodiment, respective discharge timings are controlled by the design of respective electrode areas and lengths of the sustain electrodes X and the scan electrodes Y used for sustain discharge.

The first cell A has a large electrode area of X and a small electrode area of Y. The second cell B has a small electrode area of X and a large electrode of Y. These cells (A, B) take a zigzag arrangement pattern. For example, discharge gap lengths of respective cells are uniform.

When electrode areas of X and Y in the cell are varied like in this configuration, a difference in discharge timing due to polarity of discharge occurs from the difference in diffusion speed between ions and electrons.

Also, when the discharge gap lengths of respective cells are made uniform like in this configuration, the firing voltages become equal, and such an effect can be obtained that the adverse effect to a reset operation caused by the difference in firing voltage or the like can be suppressed to the minimum.

In FIG. 8, the sustain electrode X (transparent electrode 2a, bus electrode 2b) has small area and length L1 in the y direction and the scan electrode Y (transparent electrode 2a, bus electrode 2b) has large area and length L2 in the y direction in the cell A. On the contrary, the sustain electrode X (transparent electrode 2a, bus electrode 2b) has large area and length L2 in the y direction and the scan electrode Y (transparent electrode 2a, bus electrode 2b) has small area and length L1 in the y direction in the cell B. The above design can be considered as a structure in which lengths of the rectangular projections of the transparent electrodes 2a are varied.

### Third Embodiment

In a PDP according to a third embodiment, an error diffusion processing pattern is used as an applicable structure other than the zigzag arrangement pattern shown in the first and second embodiments. For example, two types of cells (A, B) are provided like in the first embodiment and others. Then, in the third embodiment, the respective cells (A, B) are arranged by using a pattern determined by a predetermined (known) error diffusion processing so that they are equal in number on a screen. For example, a predetermined error diffusion processing is performed with setting the cell A as a numeral value 1 and the cell B as a numeral value 0. The cells A and the cells B are arranged in a display region in accordance with the pattern of bitmap data obtained by the processing.

Note that, in this pattern, cells of the same type are arranged in adjacent cells in some parts. It is visually preferable to adopt the arrangement in which the cells of the same type are contained in a block with a size of 2×2 in the vertical and horizontal directions.

As described above, various arrangement patterns in which luminance unevenness is hardly recognized as noise visually can be used.

### Fourth Embodiment

In a PDP according to a fourth embodiment, in addition to the structures according to the first and second embodiments and others described above, luminance gradient (shading structure) is provided in a screen by means of arrangement pattern. For example, two types of cells (A, B) are provided like the above, they are arranged on a screen in accordance with the error diffusion processing pattern or the like in the same manner as the third embodiment, and the luminance gradient in the screen is provided in accordance with a ratio in the arrangement (the number of cells per unit area). For example, the ratio of the cells B is made high at a central portion of the screen so that an average value of discharge gap lengths is made large (light emission and luminance are relatively reduced), and the ratio of cells A is made high in a peripheral portion of the screen so that the average value is made small (light emission and luminance are relatively increased). The cells are arranged so that the luminance gradient varies continuously from the central portion of the screen toward the peripheral portion thereof.

Also, the structure having a luminance gradient reverse to the above (structure where luminance is large in the central portion and luminance is small in the peripheral portion) can be adopted.

As described above, not only the luminance unevenness reduction effect can be obtained, but also shading structure and the like can be added in accordance with the arrangement pattern.

### Fifth Embodiment

Next, a PDP, a PDP apparatus and a PDP driving method according to a fifth embodiment will be described. In the fifth embodiment, a drive waveform applied from a drive control circuit to electrodes of the PDP 10 is ingeniously controlled. Drive waveforms of corresponding types are applied from the control circuit 110 and the respective drivers shown in FIG. 1 to the respective cells (A, B) of the PDP 10 mentioned above.

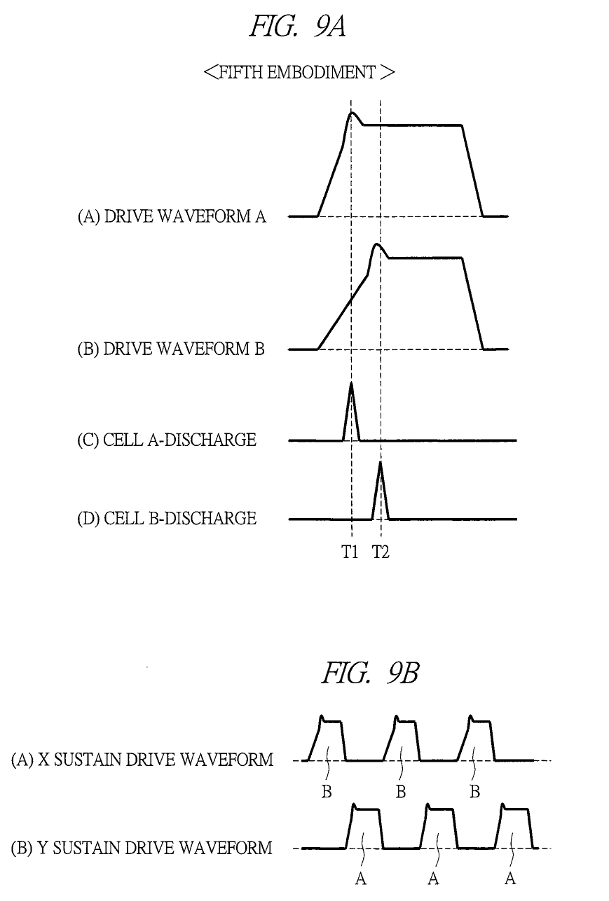

FIG. 9 shows the design of cells and drive waveforms according to the fifth embodiment. In FIG. 9A, (A) denotes a drive waveform A and (B) denotes a drive waveform B as different types of drive waveforms (sustain pulses), and as discharge light emissions corresponding to these drive waveforms, (C) denotes discharge light emission (timing: T1) of the cell A and (D) denotes discharge light emission (timing: T2) of the cell B. In FIG. 9B, as sustain drive waveforms (sustain impulse group) to the display electrode pairs (X-Y), (A) denotes a waveform to the sustain electrode X and (B) denotes a waveform to the scan electrode Y.

The PDP 10 according to the fifth embodiment can use a structure similar to that of each of the above-mentioned embodiments. For example, a zigzag arrangement pattern of two types of cells (A, B) similar to that of the first embodiment can be adopted. Then, in the PDP driving method and the PDP apparatus according to the fifth embodiment, the two types of drive waveforms A and B are used in combination in the sustain drive waveforms to the display electrode pairs (X, Y) of the PDP 10. Specifically, a first drive waveform A of (A) including overshoot at the same timing (T1) as the cell (cell A) discharging early as shown by (C) in FIG. 9A and a second drive waveform B of (B) including overshoot at the same timing as the cell (cell B) discharging late as shown by (D) in FIG. 9A are prepared. For the application of the drive waveform A, the cell A discharging early becomes relatively bright because it coincides with the timing of overshoot (rising). Similarly, for the application of the drive waveform B, the cell B discharging late becomes bright.

In the present PDP driving method, sustain drive operation is performed to the display electrode pairs (X, Y) by using the drive waveforms (A, B) approximately equal in number in accordance with the arrangement pattern of the PDP 10. In the example shown in FIG. 9B, the second drive waveform B (unit sustain pulse) is repeatedly applied to the sustain electrodes X, and the first drive waveform A is repeatedly applied to the scan electrodes Y. Besides, it is also possible to apply the drive waveform A to X and apply the drive waveform B to Y or repeatedly apply the drive waveforms A and B to the respective electrodes (X, Y) alternately at a proper cycle.

According to this configuration, it is possible to reduce luminance difference due to a fixed arrangement pattern owned by the PDP 10 of the respective embodiments.

In the foregoing, the invention made by the inventors of the present invention has been concretely described based on the embodiments. However, it is needless to say that the present invention is not limited to the foregoing embodiments and various modifications and alterations can be made within the scope of the present invention. For example, it is also possible to provide three or more types of cells instead of two types of cells.

The present invention can be utilized in a display device such as a PDP.

What is claimed is:

1. A plasma display panel,
wherein plural types of cells different in discharge timing with respect to a reference waveform application are provided,
the plural types of cells have different discharge timings because lengths of discharge gaps are varied by electrode shapes of the respective cells, and
the plural types of cells are arranged on a screen in a sequentially repetitive pattern so that cells of different types are arranged in adjacent cells.

2. A plasma display panel,
wherein plural types of cells different in discharge timing with respect to a reference waveform application are provided,
the plural types of cells have different discharge timings because positions of discharge gaps are varied by electrode shapes of the respective cells, and
the plural types of cells are arranged on a screen in a sequentially repetitive pattern so that cells of different types are arranged in adjacent cells.

3. The plasma display panel according to claim 1,
wherein the plural types of cells are two types of cells, and
the two types of cells are alternately arranged in a vertical direction and a horizontal direction of the screen.

4. The plasma display panel according to claim 3,
wherein discharge timings of first and second cells in the two types of cells are set to have a difference of about half-height full-width of the waveform by a design of the display gaps.

5. The plasma display panel according to claim 1,
wherein a pair of first and second electrodes forming the discharge gap is provided,
the first and second electrodes have linear bus electrodes and transparent electrodes in a rectangular shape projecting from the bus electrodes to form the discharge gap,
a difference in the length of the discharge gaps in the plural types of cells is formed by a difference in length of the projections of the first and second electrodes of each cell extending in a cell inner side direction, and
in the plural types of cells, lengths of the projections of the transparent electrodes of the first and second electrodes are large in a first cell and lengths of the projections of the transparent electrodes of the first and second electrodes are small in a second cell.

6. The plasma display panel according to claim 2,
wherein a pair of first and second electrodes forming the discharge gap is provided,
the first and second electrodes have linear bus electrodes and transparent electrodes in a rectangular shape projecting from the bus electrodes to form the discharge gap,
a difference in the position of the discharge gaps in the plural types of cells is formed by a distribution of areas and lengths of projections of the first and second electrodes of each cell extending in an cell inner side direction, and
in the plural types of cells, the first electrode is larger in area and length of the projection of the transparent electrode than the second electrode in a first cell, and the second electrode is larger in area and length of the projection of the transparent electrode than the first electrode in a second cell.

7. The plasma display panel according to claim 6,
wherein the lengths of the discharge gaps of the first and second cells are equal to each other.

8. A plasma display panel,
wherein plural types of cells different in discharge timing with respect to a reference waveform application are provided,
the plural types of cells have different discharge timings because lengths or positions of discharge gaps are varied by electrode shapes of the respective cells,
a pattern of arrangement of the plural types of cells is formed so that gradient of luminance in a screen is provided by varying an arrangement ratio of the plural types of cells between a central portion of the screen and a peripheral portion of the screen, and
the plural types of cells are arranged on the screen in a sequentially repetitive pattern including a portion where cells of the same type are arranged in adjacent cells or in a pattern obtained by error diffusion processing, and the portion where the cells of the same type are arranged adjacent to each other is contained in a block with a size of 2×2 in vertical and horizontal directions at a maximum on a whole screen.

9. A driving method of a plasma display panel,
wherein, in the plasma display panel,
plural types of cells different in discharge timing with respect to a reference waveform application are provided,
the plural types of cells have different discharge timings because lengths or positions of discharge gaps are varied by electrode shapes of the respective cells, and
the plural types of cells are arranged on a screen in a sequentially repetitive pattern so that cells of different types are arranged in adjacent cells, and
in a drive control method performed by application of waveforms to first and second electrodes of the plasma display panel, as sustain drive waveforms to first and second cells in the plural types of cells, a first drive waveform which generates rising to a predetermined voltage and overshoot at a first timing coinciding with a discharge timing of the first cell and a second drive waveform which generates rising to a predetermined voltage and overshoot at a second timing coinciding with a discharge timing of the second cell are prepared, and the first drive waveform and the second drive waveform are applied in a switched manner so that numbers of the first and second drive waveforms correspond to arrangement ratios of the respective cells in the pattern.

10. A plasma display apparatus comprising:
a plasma display panel; and a circuit unit for driving and controlling the plasma display panel,
wherein, in the plasma display panel,
plural types of cells different in discharge timing with respect to a reference waveform application are provided,
the plural types of cells have different discharge timings because lengths or positions of discharge gaps are varied by electrode shapes of the respective cells, and
the plural types of cells are arranged on a screen in a sequentially repetitive pattern so that cells of different types are arranged in adjacent cells, and
in the circuit unit,
in drive control performed by application of waveforms to first and second electrodes of the plasma display panel, as sustain drive waveforms to first and second cells in the plural types of cells, a first drive waveform which generates rising to a predetermined voltage and overshoot at a first timing coinciding with a discharge timing of the first cell and a second drive waveform which generates rising to a predetermined voltage and overshoot at a second timing coinciding with a discharge timing of the second cell are prepared, and the first drive waveform and the second drive waveform are applied in a switched manner so that numbers of the first and second drive waveforms correspond to arrangement ratios of the respective cells in the pattern.
